(19) United States
(12) Patent Application Publication
(10) Pub. No.: US 2025/0044933 A1
(43) Pub. Date: Feb. 6, 2025

(54) GROUP CREATION IN A VIRTUAL ENVIRONMENT

(71) Applicant: Tencent Technology (Shenzhen) Company Limited, Shenzhen (CN)

(72) Inventor: Teng CHEN, Shenzhen (CN)

(73) Assignee: Tencent Technology (Shenzhen) Company Limited, Shenzhen (CN)

(21) Appl. No.: 18/920,595

(22) Filed: Oct. 18, 2024

Related U.S. Application Data
(63) Continuation of application No. PCT/CN2023/113562, filed on Aug. 17, 2023.

(30) Foreign Application Priority Data
Sep. 21, 2022 (CN) 202211153814.X

(51) Int. Cl. G06F 3/0488; G06F 3/0486

(52) U.S. Cl. CPC G06F 3/0488; G06F 3/0486

(57) ABSTRACT

In a method for creating a group in a virtual environment, a first virtual object and a plurality of second virtual objects are displayed in the virtual environment. A touch input is received on at least one of the plurality of second virtual objects. Based on the at least one of the plurality of second virtual objects including at least two second virtual objects of the plurality of second virtual objects, the at least two second virtual objects from the plurality of second virtual objects are selected as group creation virtual objects. The group that includes the first virtual object and the group creation virtual objects is created. Apparatus and non-transitory computer-readable storage medium counterpart embodiments are also contemplated.

### RELATED APPLICATIONS

The present application is a continuation of International Application No. PCT/CN2023/113562, filed on Aug. 17, 2023, which claims priority to Chinese Patent Application No. 202211153814.X, filed on Sep. 21, 2022. The entire disclosures of the prior applications are hereby incorporated by reference.

### FIELD OF THE TECHNOLOGY

This application relates to the field of virtual scene technologies, including a group establishment in a virtual scene.

### BACKGROUND OF THE DISCLOSURE

Currently, some social application programs, such as an instant messaging application program or a social platform application program, have a group establishment function.

In the related art, when a user establishes a group, usually, the user may open a contact list, select a plurality of contacts one by one from the contact list, and then tap a group establishment control to trigger establishing of a group including the user and the plurality of contacts selected.

In the foregoing solution, a process of establishing the group relates to a plurality of operations such as opening the contact list, selecting the contacts, and triggering the group establishment control. User operations are complicated. Consequently, efficiency of human-computer interaction when the user establishes the group is affected.

### SUMMARY

Embodiments of this disclosure include a method, an apparatus, and a non-transitory computer-readable storage medium for creating a group in a virtual environment. Examples of technical solutions in the embodiments of this disclosure may be implemented as follows:

An aspect of this disclosure provides a method for creating a group in a virtual environment. A first virtual object and a plurality of second virtual objects are displayed in the virtual environment. A touch input is received on at least one of the plurality of second virtual objects. Based on the at least one of the plurality of second virtual objects including at least two second virtual objects of the plurality of second virtual objects, the at least two second virtual objects from the plurality of second virtual objects are selected as group creation virtual objects. The group that includes the first virtual object and the group creation virtual objects is created.

An aspect of this disclosure provides an apparatus. The apparatus includes processing circuitry configured to display a first virtual object and a plurality of second virtual objects in a virtual environment. The processing circuitry is configured to receive a touch input on at least one of the plurality of second virtual objects. Based on the at least one of the plurality of second virtual objects including at least two second virtual objects of the plurality of second virtual objects, the processing circuitry is configured to select the at least two second virtual objects from the plurality of second virtual objects as group creation virtual objects. The processing circuitry is configured to create a group that includes the first virtual object and the group creation virtual objects.

An aspect of this disclosure provides a non-transitory computer-readable storage medium storing instructions which when executed by a processor cause the processor to perform any of the methods of this disclosure.

Technical solutions provided in embodiments of this disclosure can have the following beneficial effects:

n group establishment virtual objects selected by a user are determined directly by a received touch operation on all or a part of at least two second virtual objects. Then a group of the n group establishment virtual objects and a first virtual object corresponding to the user is established. With the help of an interaction manner in the virtual scene, an operation of group establishment is greatly simplified, thereby improving efficiency of human-computer interaction when the user establishes the group.

### BRIEF DESCRIPTION OF THE DRAWINGS

FIG. 1 is a schematic diagram of a computer device system according to an embodiment of this disclosure.

FIG. 2 is a schematic diagram of a display interface of a virtual scene according to an embodiment of this disclosure.

FIG. 3 is a flowchart of a group establishment method for a virtual scene according to an embodiment of this disclosure.

FIG. 4 is a flowchart of a group establishment method for a virtual scene according to an embodiment of this disclosure.

FIG. 5 is a schematic diagram of a transformation process from three-dimensional space to a two-dimensional image according to an embodiment of this disclosure.

FIG. 6 is a diagram of an operation interface according to an embodiment of this disclosure.

FIG. 7 is a diagram of an operation interface according to an embodiment of this disclosure.

FIG. 8 is an operation flowchart according to an embodiment of this disclosure.

FIG. 9 is a diagram of an operation interface according to an embodiment of this disclosure.

FIG. 10 is a diagram of a time sequence according to an embodiment of this disclosure.

FIG. 11 is a diagram of an operation interface according to an embodiment of this disclosure.

FIG. 12 is a block diagram of a group establishment apparatus for a virtual scene according to an embodiment of this disclosure.

FIG. 13 is a block diagram of a structure of a computer device according to an embodiment of this disclosure.

FIG. 14 is a block diagram of a structure of a computer device according to an embodiment of this disclosure.

### DESCRIPTION OF EMBODIMENTS

For convenience of understanding, several terms in embodiments of this disclosure are described. The descriptions of the terms are provided as examples only and are not intended to limit the scope of the disclosure.

(1) Virtual scene: The virtual scene is a virtual scene displayed (or provided) by an application program when the application program is run on a terminal. The virtual scene may be a simulated environment scene of a real world, or may be a semi-simulated and semi-fictional three-dimensional environment scene, or may further be an entirely fictional three-dimensional environment scene. The virtual scene may be any one of a two-dimensional virtual scene, a 2.5-dimensional virtual scene, and a three-dimensional virtual scene. In some embodiments, the virtual scene may further be configured for social interaction, a virtual scene battle, and the like between at least two virtual objects.

The virtual scene is usually generated by an application program in a computer device such as the terminal and presented based on hardware (for example, a screen) in the terminal. The terminal may be a mobile terminal such as a smartphone, a tablet computer, or an e-book reader. Alternatively, the terminal may be a personal computer device such as a notebook computer or a fixed computer.

(2) Virtual object: The virtual object is a movable object in a virtual scene. The movable object may be at least one of a virtual human, a virtual animal, and a virtual vehicle. In some embodiments, when the virtual scene is a three-dimensional virtual scene, the virtual object is a three-dimensional model established based on a skeletal animation technology. Each virtual object has an own shape, an own volume and an own orientation in the three-dimensional virtual scene, and occupies some space in the three-dimensional virtual scene.

(3) Virtual social intercourse: A user customizes an own 2-dimensional (2D) or 3-dimensional (3D) humanoid model through do-it-yourself (DIY), and performs social interaction such as chatting with another user with a virtual character/figure of the user.

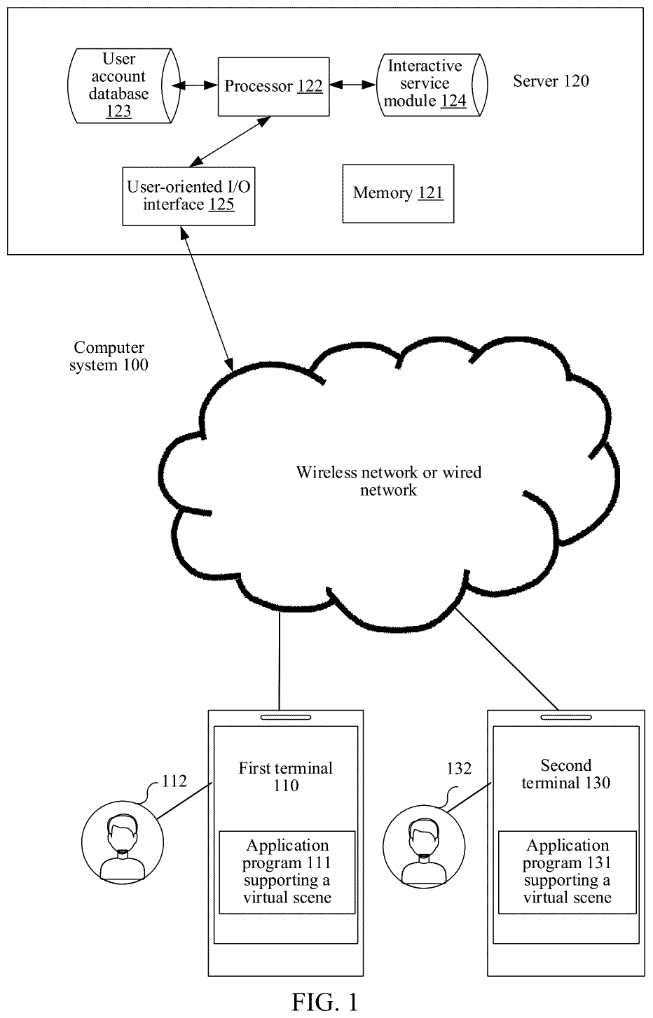

FIG. 1 is a schematic diagram of a computer device system according to an embodiment of this disclosure. The computer device system 100 may include: a first terminal 110, a server 120, and a second terminal 130.

An application program 111 supporting a virtual scene is installed and run on the first terminal 110, and the application program 111 may be a multiplayer online social interaction program. When the first terminal runs the application program 111, a user interface of the application program 111 is displayed on a screen of the first terminal 110. In some embodiments, the application program 111 may alternatively be any one of a multiplayer online battle arena game (MOBA), a battle royale shooting game, and a simulation game (SLG). The first terminal 110 is a terminal used by a first user 112. The first user 112 uses the first terminal 110 to control a virtual object A in the virtual scene to perform an activity, and the virtual object A may be referred to as a main control virtual object of the first user 112. For example, the first virtual object A is a first virtual character such as a simulated person or a cartoon person.

An application program 131 supporting a virtual scene is installed and run on the second terminal 130, and the application program 131 may be a multiplayer online social interaction program. When the second terminal 130 runs the application program 131, a user interface of the application program 131 is displayed on a screen of the second terminal 130. In some embodiments, the application program 131 may alternatively be any one of a MOBA game, a battle royale shooting game, and an SLG game. The second terminal 130 is a terminal used by a second user 132. The second user 132 uses the second terminal 130 to control a virtual object B in the virtual scene to perform an activity, and the virtual object B may be referred to as a main control virtual object of the second user 132. For example, the virtual object B is a second virtual character, such as a simulated character or a cartoon character.

In some embodiments, the virtual object A and the virtual object B are located in a same virtual world. In some embodiments, the virtual object A and the virtual object B may belong to a same camp, a same team, or a same organization, and have a friend relationship with each other, or have a temporary communication permission. In some embodiments, the virtual object A and the virtual object B may belong to different camps, different teams, or different organizations, or have a hostile relationship with each other.

In some embodiments, the application programs installed on the first terminal 110 and the second terminal 130 are the same, or the application programs installed on the two terminals are application programs of a same type in different operating system platforms (Android or iOS). The first terminal 110 may refer to one of a plurality of terminals, and the second terminal 130 may refer to another one of the plurality of terminals. In this embodiment, the first terminal 110 and the second terminal 130 are merely used as an example for description. Device types of the first terminal 110 and the second terminal 130 are the same or different. The device type includes at least one of a smartphone, a tablet computer, an e-book reader, a Moving Picture Experts Group Audio Layer III (MP3) player, a Moving Picture Experts Group Audio Layer IV (MP4) player, a laptop portable computer, and a desktop computer.

FIG. 1 shows two terminals. However, a plurality of other terminals may access the server 120 in different embodiments. In some embodiments, one or more terminals are terminals corresponding to a developer. A developing and editing platform for the application program supporting a virtual scene is installed on the terminal. The developer may edit and update the application program on the terminal and transmit an updated application program installation package to the server 120 through a wired or wireless network. The first terminal 110 and the second terminal 130 may download the application program installation package from the server 120 to update the application program.

The first terminal 110, the second terminal 130, and the other terminals are connected to the server 120 through a wireless network or a wired network. The server 120 includes at least one of one server, a server cluster including a plurality of servers, a cloud computing platform, and a virtualization center. The server 120 is configured to provide a backend service for the application program supporting a virtual scene. In some embodiments, the server 120 is responsible for primary computing work, and the terminal is responsible for secondary computing work. Alternatively, the server 120 is responsible for secondary computing work, and the terminal is responsible for primary computing work. Alternatively, a distributed computing architecture is used between the server 120 and the terminal to perform collaborative computing.

In an example, the server 120 includes a memory 121, a processor 122, a user account database 123, an interactive service module 124, and a user-oriented input/output interface (I/O interface) 125. The processor 122 is configured to load instructions stored in the server 120, and process data in the user account database 123 and the interactive service module 124. The user account database 123 is configured to store data of user accounts used by the first terminal 110, the second terminal 130, and the other terminals, for example, avatars, nicknames, battle effectiveness indexes, and service zones of the user accounts. The interactive service module 124 is configured to provide a virtual scene for a user to interact with a virtual object of another user, such as social interaction and a battle. The user-oriented I/O interface 125 is configured to establish communication with the first terminal 110 and/or the second terminal 130 through a wireless network or a wired network for data exchange.

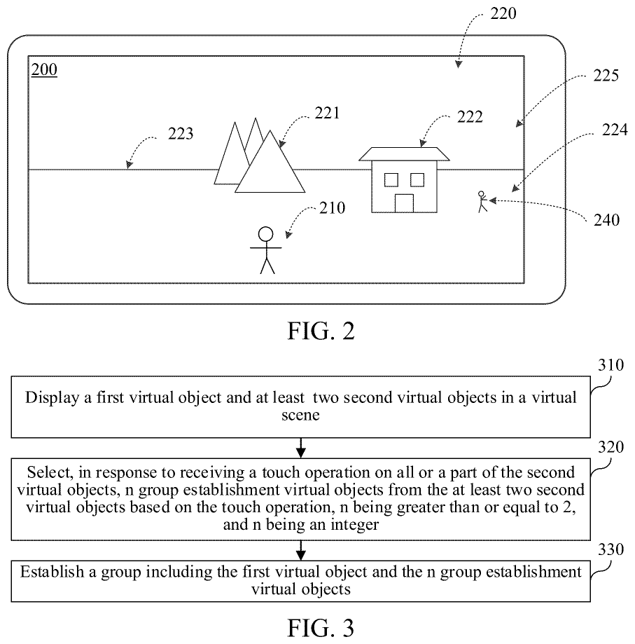

The virtual scene may be a three-dimensional virtual scene or a two-dimensional virtual scene. An example in which the virtual scene is a three-dimensional virtual scene is used. FIG. 2 is a schematic diagram of a display interface of a virtual scene according to an embodiment of this disclosure. As shown in FIG. 2, the display interface of the virtual scene includes a scene picture 200. The scene picture 200 includes a virtual object 210 currently controlled, an environment picture 220 of the three-dimensional virtual scene, and a virtual object 240. The virtual object 240 may be a virtual object controlled by a user corresponding to another terminal or a virtual object controlled by an application program.

In FIG. 2, the virtual object 210 currently controlled and the virtual object 240 are three-dimensional models in the three-dimensional virtual scene. The environment picture that is of the three-dimensional virtual scene and that is displayed in the scene picture 200 is an object observed from a perspective of the virtual object 210 currently controlled. For example, as shown in FIG. 2, the displayed environment picture 220 that is of the three-dimensional virtual scene and that is observed from the perspective of the virtual object 210 currently controlled is ground 224, sky 225, a horizon 223, a hill 221 and a factory building 222.

The virtual object 210 currently controlled may move, interact with an item in the virtual scene, such as a virtual item or a virtual building, and perform social interaction with another virtual object (such as the virtual object 240) in the virtual scene under control of a user.

FIG. 3 is a flowchart of a group establishment method for a virtual scene according to an embodiment of this disclosure. The group establishment method for the virtual scene may be performed by a computer device. The computer device may be a terminal or a server, or the computer device may include the foregoing terminal and server. As shown in FIG. 3, the group establishment method for the virtual scene includes the following operations.

Operation 310: Display a first virtual object and at least two second virtual objects in the virtual scene. For example, a first virtual object and a plurality of second virtual objects are displayed in the virtual environment.

The first virtual object may be a virtual object corresponding to a terminal displaying a scene interface. For example, the foregoing first virtual object may be a virtual object corresponding to a user account logged-in on the terminal, and the first virtual object is controlled by the terminal.

The foregoing second virtual object may be a virtual object other than the first virtual object. For example, the second virtual object may be a virtual object controlled by another terminal or a virtual object controlled by AI.

In a possible implementation, in the virtual scene, a distance between the second virtual object and the first virtual object is inversely correlated with an intimacy degree of a social relationship between the first virtual object and the second virtual object. In other words, a closer social relationship between the second virtual object and the first virtual object indicates a smaller distance between the second virtual object and the first virtual object.

The foregoing virtual scene may be a virtual scene configured for social interaction. For example, the virtual scene may be a virtual scene based on a social interaction application program. The first virtual object in the virtual scene may be a virtual figure corresponding to a user account logged-in on the current terminal, and the second virtual object in the virtual scene may be a virtual figure corresponding to a friend account of the user account logged-in on the current terminal. Both the foregoing user account and the foregoing friend account are accounts in the social interaction application program.

In some other possible solutions, the foregoing virtual scene may alternatively be a game virtual scene. For example, the foregoing virtual scene may be a game scene of a battle game. The first virtual object in the game scene may be a virtual character corresponding to a player account logged-in on the current terminal, and the second virtual object in the virtual scene may be a virtual character corresponding to another player account participating in the game. Both the foregoing player accounts are accounts in the game.

Operation 320: Select, in response to receiving a touch operation on all or a part of the second virtual objects, n group establishment virtual objects from the at least two second virtual objects based on the touch operation, n being greater than or equal to 2, and n being an integer. For example, a touch input on at least one of the plurality of second virtual objects is received. Based on the at least one of the plurality of second virtual objects including at least two of the plurality of second virtual objects, at least two second virtual objects from the plurality of second virtual objects are selected as group creation virtual objects.

In this embodiment of this disclosure, a user may select the n group establishment virtual objects from the at least two second virtual objects by performing the touch operation on all or the part of the at least two second virtual objects.

The foregoing touch operation is implemented in a virtual interface.

Operation 330: Establish a group including the first virtual object and the n group establishment virtual objects. For example, the group that includes the first virtual object and the group creation virtual objects is created.

The computer device may establish the group including the first virtual object, namely, the user, and the n group establishment virtual objects after the user selects the n group establishment virtual objects.

The foregoing group may be a chat group for instant messaging. Alternatively, the group may be a group for other interaction such as a game battle (for example, a board game). A type of the foregoing group is not limited in this embodiment of this disclosure.

In the foregoing solution, the user only needs to perform a selection operation on the virtual objects to complete group establishment. Therefore, operations such as opening an object list and triggering a group establishment control in a process in which the user establishes the group are omitted.

In conclusion, in the solution shown in this embodiment of this disclosure, the n group establishment virtual objects selected by the user are determined directly by the received touch operation on all or the part of the at least two second virtual objects. Then the group of the n group establishment virtual objects and the first virtual object corresponding to the user is established. With help of an interaction manner in the virtual scene, an operation of group establishment is greatly simplified, thereby improving efficiency of human-computer interaction when the user establishes the group. In addition, in the manner provided in this solution, in virtual social intercourse in which a virtual character is an object, an advantage such as a character position in a scene can be used by the user to quickly locate and find an object that the user wants to perform group chatting with and quickly recruit the object to establish a group chat. A new manner of starting chatting in the virtual social intercourse is introduced.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

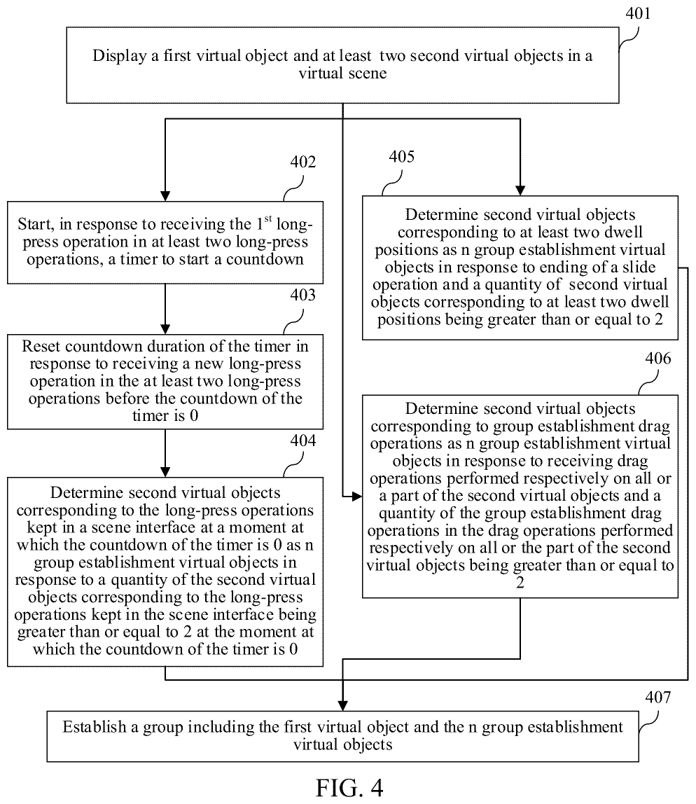

FIG. 4 is a flowchart of a group establishment method for a virtual scene according to an embodiment of this disclosure. The group establishment method for the virtual scene may be performed by a computer device. The computer device may be a terminal or a server, or the computer device may include the foregoing terminal and server. As shown in FIG. 4, the group establishment method for the virtual scene includes the following operations.

Operation 401: Display a first virtual object and at least two second virtual objects in the virtual scene. For example, a first virtual object and a plurality of second virtual objects are displayed in the virtual environment.

In this embodiment of this disclosure, the computer device may sequentially determine, in response to receiving a touch operation on all or a part of the at least two second virtual objects, n group establishment virtual objects from the at least two second virtual objects based on the touch operation, n being greater than or equal to 2, and n being an integer.

The foregoing touch operation may have a plurality of operation manners, provided that a user can implement a selection operation on a plurality of second virtual objects through the touch operation.

In a possible implementation, the foregoing touch operation includes at least two long-press operations performed successively, and the long-press operation is an operation of long pressing a position of the second virtual object. In this case, a manner of determining the n group establishment virtual objects may be as shown in the following operation 402 to operation 404.

Operation 402: Start, in response to receiving the 1^{st} long-press operation in the at least two long-press operations, a timer to start a countdown. For example, a countdown timer is initiated when receiving a first long-press operation on one of the at least two of the plurality of second virtual objects.

In this embodiment of this disclosure, when the computer device first detects one long-press operation on one second virtual object by the user, the timer may be started to perform the countdown at initial duration, to determine whether to enter a group establishment mode.

Operation 403: Reset countdown duration of the timer in response to receiving a new long-press operation in the at least two long-press operations before the countdown of the timer is 0. For example, the countdown timer is reset in response to receiving each subsequent long-press operation of the plurality of long-press operations before the countdown timer reaches zero.

In a process in which the computer device performs the countdown by using the timer, the computer device may continue detecting whether there is a new long-press operation, in other words, detecting whether the user performs a long-press operation on another second virtual object within the countdown. If the user performs a long-press operation on another second virtual object within the countdown, the computer device may reset the countdown duration of the timer, to facilitate detecting whether the user continues selecting another second virtual object to join the group.

The initial countdown duration of the foregoing timer and countdown duration of the timer after resetting are the same, for example, both are 2 s.

Alternatively, the initial countdown duration of the foregoing timer and countdown duration of the timer after resetting are different. For example, the foregoing initial countdown duration may be 2 s, and the sequential countdown duration of the timer after each time of resetting may be 3 s.

In a process of the countdown of the foregoing timer, the user may alternatively select to release one or more long-press operations. For example, when the user temporarily decides not to add a second virtual object currently long pressed to the group, the user may release a long-press operation on the second virtual object.

Further, in the process in which the computer device performs the countdown by using the timer, if the computer device detects that the user releases all the long-press operations, the computer device may cancel the foregoing timer and exit a process of determining whether to enter the group establishment mode. Alternatively, if the computer device already enters the group establishment mode, the computer device may exit the group establishment mode.

Operation 404: Determine second virtual objects corresponding to the long-press operations at a moment at which the countdown of the timer is 0 as the n group establishment virtual objects in response to a quantity of the second virtual objects corresponding to the long-press operations being greater than or equal to 2 at the moment at which the countdown of the timer is 0. For example, when the countdown timer reaches zero and at least two long-press operations are received, the at least two second virtual objects corresponding to the received long-press operations are selected as the group creation virtual objects.

In a process in which the user selects the second virtual object, with an increase of a quantity of times for which the long-press operation is performed, the computer device may perform operation 402 to operation 403 cyclically until the countdown of the timer is 0, or until all the long-press operations are released.

In the process in which the computer device performs the countdown by using the timer, if the computer device detects that the countdown of the timer ends, the computer device may determine that the user completes selecting the second virtual object. In this case, the computer device further determines whether the quantity of the second virtual objects corresponding to the long-press operations is greater than or equal to 2. If the quantity of the second virtual objects corresponding to the long-press operations is greater than or equal to 2, the second virtual objects corresponding to the long-press operations currently kept are determined as the n group establishment virtual objects to join the group.

In another possible implementation, a management menu of a second virtual object corresponding to the long-press operations is displayed in response to the quantity of the second virtual objects corresponding to the long-press operations being 1 at the moment at which the countdown of the timer is 0.

In a process in which the computer device performs the countdown by using the timer, if the computer device detects that the countdown of the timer ends, and further determines that the quantity of the second virtual objects corresponding to the long-press operations is equal to 1, the computer device determines not to establish a group. In this case, the computer device may display the management menu of the second virtual object corresponding to the long-press operations. The management menu may be a menu for managing the single second virtual object currently long pressed. For example, the foregoing management menu may include one or more interaction controls of the single second virtual object, and each interaction control may correspond to one interaction operation such as a private message or state viewing.

In another possible implementation, the touch operation includes a slide operation, the slide operation includes at least two dwell positions, and the dwell position is a position at which dwelling duration during the slide operation reaches a duration threshold. In this case, a manner of determining the n group establishment virtual objects may be as shown in the following operation 405.

Operation 405: Determine second virtual objects corresponding to the at least two dwell positions as the n group establishment virtual objects in response to ending of the slide operation and a quantity of the second virtual objects corresponding to the at least two dwell positions being greater than or equal to 2. For example, when the slide operation is completed and at least two pause positions are detected, the at least two second virtual objects corresponding to the detected pause positions are selected as the group creation virtual objects.

In a possible implementation of this disclosure, a user may alternatively perform the slide operation and dwell at positions of the virtual objects that the user wants to add to the group, to select the n virtual objects that the user wants to add to the group. Specifically, when the computer device detects that the slide operation ends, the computer device may determine whether the quantity of the second virtual objects at the dwell positions during the slide operation is greater than or equal to 2. If the quantity of the second virtual objects at the dwell positions during the slide operation is greater than or equal to 2, the computer device determines to establish the group and determines the second virtual objects at the dwell positions during the slide operation as the n group establishment virtual objects.

For example, the duration threshold is 0.5 s. If the user wants to add a virtual object 1, a virtual object 2, and a virtual object 3 to the group, the user may slide in the virtual scene and dwell at a position of the virtual object 1 for at least 0.5 s. Then the user may continue to slide to the virtual object 2 and dwell at a position of the virtual object 2 for at least 0.5 s. Then the user may continue to slide to the virtual object 3 and dwell at a position of the virtual object 3 for at least 0.5 s, and release the slide operation. In this case, the computer device determines that a quantity of the second virtual objects at the positions at which the user dwells during the slide operation is greater than 2 (the quantity is 3). In this case, the virtual objects 1 to 3 may be determined as the n group establishment virtual objects.

In a possible implementation, a management menu of a second virtual object corresponding to the at least two dwell positions is displayed in response to the ending of the slide operation and the quantity of the second virtual objects corresponding to the at least two dwell positions being 1.

When the computer device detects that the slide operation ends, if the computer device determines that the quantity of the second virtual objects at the dwell positions during the slide operation is equal to 1, the computer device determines not to establish a group and displays the management menu of the second virtual object at the dwell position.

In another possible implementation, the touch operation includes drag operations performed respectively on all or the part of the at least two second virtual objects. In this case, a manner of determining the n group establishment virtual objects may be as shown in the following operation 406.

Operation 406: Determine second virtual objects corresponding to group establishment drag operations as the n group establishment virtual objects in response to receiving the drag operations performed respectively on all or the part of the second virtual objects and a quantity of the group establishment drag operations in the drag operations performed respectively on all or the part of the second virtual objects being greater than or equal to 2. For example, when the plurality of drag operations are completed at a target location of a group identifier, the plurality of second virtual objects corresponding to the received drag operations are selected as the group creation virtual objects.

The group establishment drag operation is a drag operation whose ending position is a position of a specified virtual item in the virtual scene.

In a possible implementation, the foregoing drag operations performed respectively on all or the part of the at least two second virtual objects may be a plurality of drag operations simultaneously performed. When the computer device detects that a user simultaneously drags two or more second virtual objects to the position of the specified virtual item in the virtual scene, the computer device may determine to establish a group. In this case, the computer device may determine the second virtual objects simultaneously dragged to the position of the specified virtual item in the virtual scene as the n group establishment virtual objects.

In another possible implementation, the foregoing drag operations performed respectively on all or the part of the at least two second virtual objects may be a plurality of drag operations performed successively. In this case, a determining control may be displayed in the virtual scene. For example, the determining control may correspond to the specified virtual item and be displayed.

When the computer device detects a trigger operation on the determining control by a user, the computer device may determine a quantity of the second virtual objects successively dragged to the position of the specified virtual item. If the quantity of the second virtual objects successively dragged to the position of the specified virtual item is greater than or equal to 2, the computer device determines to establish a group. In this case, the computer device may determine the second virtual objects successively dragged to the position of the specified virtual item as the n group establishment virtual objects.

Alternatively, when the computer device detects that the quantity of the second virtual objects successively dragged to the position of the specified virtual item is greater than or equal to 2, the computer device displays the foregoing determining control or sets a state of the foregoing determining control to a triggerable state (if the quantity of the second virtual objects successively dragged to the position of the specified virtual item is less than 2, the computer device sets the state of the determining control to an inoperable state). Sequentially, when the computer device detects a trigger operation on the determining control by the user, the computer device determines to establish the group. In this case, the computer device may determine the second virtual objects successively dragged to the position of the specified virtual item as the n group establishment virtual objects.

The foregoing specified virtual item may be a specified type of virtual item such as a virtual chatting room, a virtual tent, or a virtual bench. A display form of the specified virtual item is not limited in this embodiment of this disclosure.

The foregoing specified virtual item may be a specified type of virtual item disposed in the virtual scene in advance. For example, when the user needs to establish a group, the user may trigger a displayed group establishment button. Then the computer device may display the specified virtual item in the virtual scene. For example, the computer device detects an idle sub-region in a region of the scene interface currently displayed in the virtual scene and display the foregoing specified virtual item in the idle sub-region. In some embodiments, the computer device may adjust a size of the specified virtual item based on a size of the idle sub-region, so that the size of the specified virtual item does not exceed the foregoing idle sub-region.

Alternatively, displaying of the foregoing specified virtual item may be triggered by a specified operation on the second virtual object in the virtual scene by the user.

In a possible implementation, before the n group establishment virtual objects are selected, in response to receiving the touch operation on all or the part of the second virtual objects, from the at least two second virtual objects based on the touch operation, the method further includes the following operations.

The computer device generates the specified virtual item in the virtual scene in response to receiving long-press operations simultaneously performed on two or more second virtual objects in the at least two second virtual objects; and displays the specified virtual item.

Before the user selects the group establishment virtual objects, the user may further simultaneously perform the long-press operations on the two or more second virtual objects in the virtual scene. In this case, the computer device may generate and display the specified virtual item in the virtual scene.

In a possible implementation, the foregoing drag operation is an operation of dragging starting from the long-press operation. In this embodiment of this disclosure, after triggering, through the long-press operations, generating and displaying of the specified virtual item in the virtual scene, the user can keep the long-press operations unreleased and directly drag the virtual objects long pressed to the position of the specified virtual item.

In some embodiments, in the foregoing solution, if the user releases the long-press operations before the virtual objects long pressed are dragged to the specified virtual item, the computer device may determine that the user abandons establishing a group. In this case, the computer device may cancel displaying of the foregoing specified virtual item.

Operation 407: Establish a group including the first virtual object and the n group establishment virtual objects. For example, the group that includes the first virtual object and the group creation virtual objects is created.

After the computer device determines the n group establishment virtual objects, the computer device may establish a new group and add the first virtual object and the selected n group establishment virtual objects to the new group.

After the group is established, the solution based on the foregoing operation 402 to operation 404 or the solution based on the foregoing operation 405 may further include the following solution.

A specified virtual item corresponding to the group is generated in the virtual scene; and the specified virtual item is displayed.

A third virtual object is added to the group in response to an operation of dragging the third virtual object to the specified virtual item.

The third virtual object is any second virtual objects other than the n group establishment virtual objects.

In this embodiment of this disclosure, for the group established according to the solution shown in the foregoing operation 402 to operation 404 or for the group established in the manner shown in the foregoing operation 405, the computer device may display the specified virtual item corresponding to the group in the virtual scene after the group is established, so that the user continues adding another second virtual object to the group. Specifically, the user may add a new group member to the group by dragging another second virtual object to the specified virtual item.

In a possible implementation, before displaying the specified virtual item, the computer device may further display an instant messaging interface corresponding to the group, where the instant messaging interface includes a return control. The foregoing operation of displaying the specified virtual item may include displaying the specified virtual item in response to receiving a trigger operation on the return control.

In some embodiments, the foregoing operation of displaying the specified virtual item may include: in response to receiving the trigger operation on the return control, return to the scene interface, and display the specified virtual item in the scene interface.

In a possible implementation, the foregoing specified virtual item may be displayed near the n group establishment virtual objects. For example, the computer device may determine a center position of a smallest inscribed circle of the foregoing n group establishment virtual objects, determine, near the center position, an idle sub-region with a shortest distance to the center position, and then display the foregoing specified virtual item in the idle sub-region. In some embodiments, the computer device may adjust a size of the specified virtual item based on an area of the idle sub-region. Correspondingly, the area of the idle sub-region needs to meet a condition of being able to accommodate the specified virtual item in a smallest size.

The user may establish a plurality of groups for the n group establishment virtual objects. For example, for virtual objects 1 to 3, the user may establish four groups, respectively a group 1 (including the virtual objects 1 and 2), a group 2 (including the virtual objects 1 and 3), a group 3 (including the virtual objects 2 and 3), and a group 4 (including the virtual objects 1, 2 and 3). As a result, if all specified virtual items corresponding to the groups established are displayed in the scene interface of the virtual scene, the scene interface may be excessively crowded, affecting interaction between the user and another virtual object. In view of this, the computer device may selectively display the specified virtual items. Specifically, for example, the computer device may display the instant messaging interface of the group after establishing the group. A member in the group may post chat content in the instant messaging interface. The instant messaging interface may include a return control and a close control. The return control is configured for triggering to return to a previous interface (namely, the foregoing scene interface) displayed before the instant messaging interface. The close control is configured for triggering to close the instant messaging interface. For a situation in which the user returns to the scene interface by using the return control, the computer device may display the foregoing specified virtual item in the scene interface. Otherwise, if the user returns to the scene interface by using the close control, the computer device may not display the foregoing specified virtual item in the scene interface.

In a possible implementation, a position of the specified virtual item in the virtual scene is moved in response to a drag operation on the specified virtual item.

To facilitate adding a distant second virtual object in the virtual scene to the foregoing group by the user, the computer device may further detect the drag operation on the specified virtual item by the user and move, based on the drag operation on the specified virtual item, the specified virtual item to a position at which the drag operation is released.

For example, if the user wants to add a distant virtual object 4 to the foregoing group and a position of the virtual object 4 is outside a display region of the scene interface, the specified virtual item corresponding to the group may be dragged near the virtual object 4. In this case, the display region of the scene interface changes with the drag operation, to display the virtual object 4 in the scene interface. Then, the user drags the virtual object 4 to the specified virtual item to implement adding the virtual object 4 to the specified virtual item.

In conclusion, in the solution shown in this embodiment of this disclosure, the n group establishment virtual objects selected by the user are determined directly by the touch operation, received in the scene interface of the virtual scene, on all or the part of the at least two second virtual objects. Then the group of the n group establishment virtual objects and the first virtual object corresponding to the user is established. With help of an interaction manner in the virtual scene, an operation of group establishment is greatly simplified, thereby improving efficiency of human-computer interaction when the user establishes the group.

In an implementation, a virtual scene is an environment in which a virtual object is located in the virtual scene in a running process of an application program in a terminal. The virtual scene is three-dimensional space. A world space coordinate system is used to describe coordinates of a three-dimensional model in the virtual scene in a same scene. The three-dimensional model is an object in the virtual scene.

For example, the world space coordinate system may be obtained by transforming the three-dimensional model in a model space coordinate system by using a model transformation matrix. The model space coordinate system indicates position information of the three-dimensional model. Coordinate information of each three-dimensional model in the model space coordinate system is unified into the world space coordinate system by using the model transformation matrix in the three-dimensional space.

For example, a three-dimensional model in the world space coordinate system is transformed into a camera space coordinate system by using a view matrix. The camera space coordinate system is configured for describing coordinates of the three-dimensional model observed through a camera model. For example, a position of the camera model is used as a coordinate origin. The three-dimensional model of the camera space coordinate system is transformed into a projection in a clip space coordinate system by using a projection matrix. The clip space coordinate system is configured for describing a projection of the three-dimensional model in a viewing frustum of the camera model. A related perspective projection matrix (a projection matrix) is configured to projecting the three-dimensional model into a model that conforms to a human eye observation rule of “near is large, and far is small”. For example, the foregoing model transformation matrix, view matrix, and projection matrix are usually referred to as a model view projection (MVP) matrix collectively.

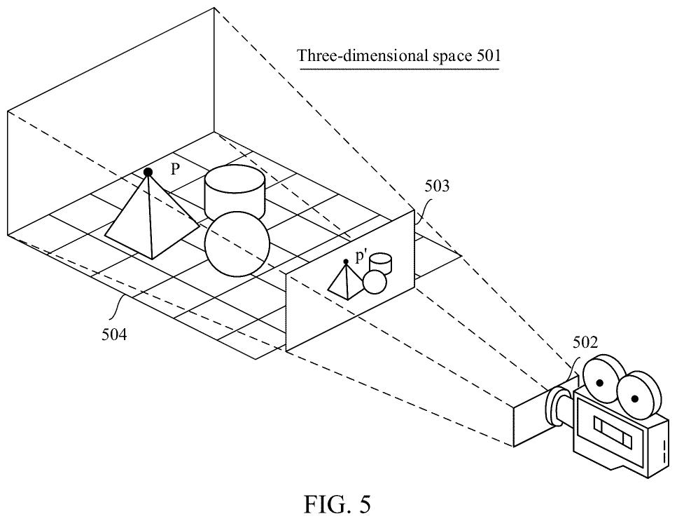

FIG. 5 is a schematic diagram of a transformation process from three-dimensional space to a two-dimensional image according to an embodiment of this disclosure. FIG. 5 shows a process of mapping a feature point P in three-dimensional space 501 to a feature point p′ in an imaging plane 503 (an image coordinate system, also referred to as a pixel coordinate system). Coordinates of the feature point P in three-dimensional space 501 are in a three-dimensional form, and coordinates of the feature point p′ in the imaging plane 503 are in a two-dimensional form. The three-dimensional space 501 is three-dimensional space corresponding to the virtual scene. A camera plane 502 is determined by a posture of a camera model. The camera plane 502 is a plane perpendicular to a shooting direction of the camera model, and the imaging plane 503 and the camera plane 502 are parallel to each other. The imaging plane 503 is a plane in which the virtual scene within a field of view is imaged by the camera model when the virtual scene is observed.

Further, the imaging plane 503 is perpendicular to a reference plane 504. A projection of the imaging plane 503 on the reference plane 504 is a straight line. An observation direction of the camera is perpendicular to the imaging plane 503. In this figure, the reference plane 504 is a horizontal plane in the three-dimensional space 501. As a position of the camera model changes, the reference plane 504 correspondingly changes to another plane. This figure only indicates that the reference plane 504 is the horizontal plane in the three-dimensional space 501 when the camera is at a current position. When the camera is at the current position, the reference plane 504 may alternatively be another plane parallel to the horizontal plane in the three-dimensional space 501.

Further, in response to a touch operation on all or a part of second virtual objects in the imaging plane 503, coordinates of the touch operation in the imaging plane 503 and mapping coordinates of the second virtual objects in the imaging plane 503 are compared, to select a second virtual object corresponding to the touch operation and determining the selected second virtual object as the group establishment virtual object.

An application scenario of the solution shown in the foregoing embodiments of this disclosure may be: in a social intercourse scene formed by virtual objects, each object corresponds to a user. A user may initiate a conversation with a single object in an operation manner of tapping the object and then selecting a chat button on a detail page or an expanded menu of the object to initiate a one-on-one conversation. This solution provides a manner for recruiting a plurality of people into a group. To be specific, after on an image of an object that a user wants to chat with in a group is long pressed for a certain time period, a person corresponding to the long pressed object and the user are recruited into the group chat, thereby implementing fast group establishment.

An interaction process and details of the solution are as follows.

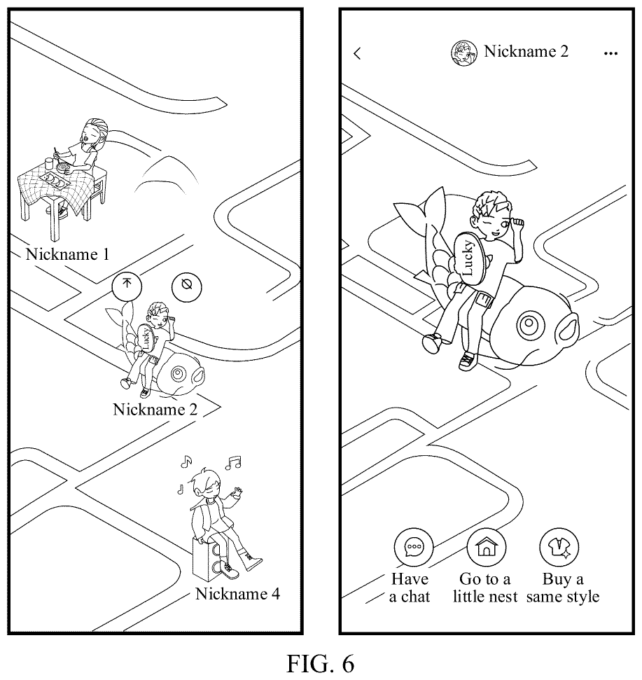

1. For a single object in a map, when the object is long pressed by using a finger, an image management function of the object is invoked, and when the object is tapped, a detail page of the object may be opened and a one-on-one chat may be performed. A diagram of an operation interface may be shown in FIG. 6.

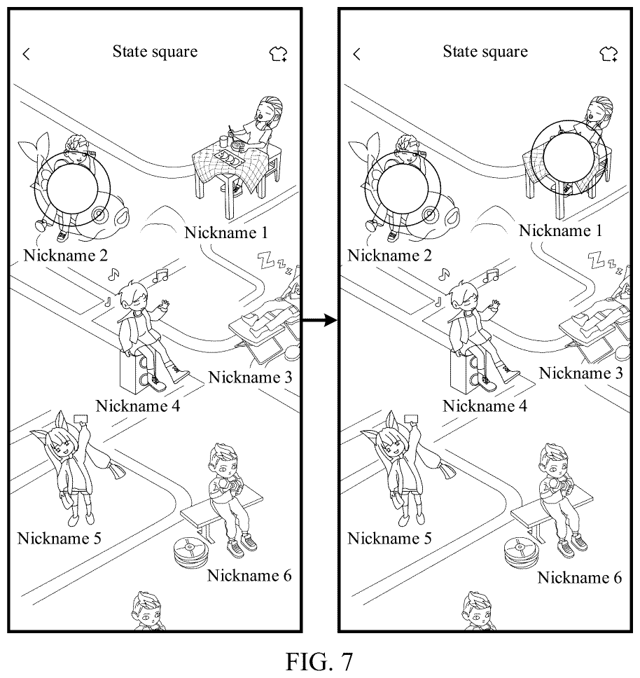

2. When a user wants to establish a group chat, the user triggers a person selection mode through long pressing. When a single person is long pressed for a certain time period (for example, 2 s), a single-person management function is invoked. Within the 2 s of long pressing, if another object is long pressed simultaneously, single-person management is not invoked but a multi-person selection group establishment mode is entered. A diagram of an operation interface may be as shown in FIG. 7.

3. Each time a new object is long pressed, duration of a countdown is refreshed and reset. The countdown is not necessarily consistent with the countdown of the single-person management function. For example, the countdown may be set to 3 s. After the countdown ends, if the user no longer long presses a new object, it is considered as that the user finishes object selection and group recruitment determining is entered.

(1) In this case, if the user long presses zero object, in other words, the user releases before the countdown ends and selects no object, it is considered as that the user abandons a group establishment operation and no function is executed.

(2) In this case, if the user long presses one object, in other words, the user originally long presses another object but then releases, and consequently, only one object is long pressed finally, group recruitment fails and the single object management function is still invoked.

(3) In this case, if the user long presses two or more objects, it is considered that the user selects the objects to preform group recruitment and recruits people corresponding to the objects and the user into a group chat. Simultaneously, a detail page of a group conversation is displayed.

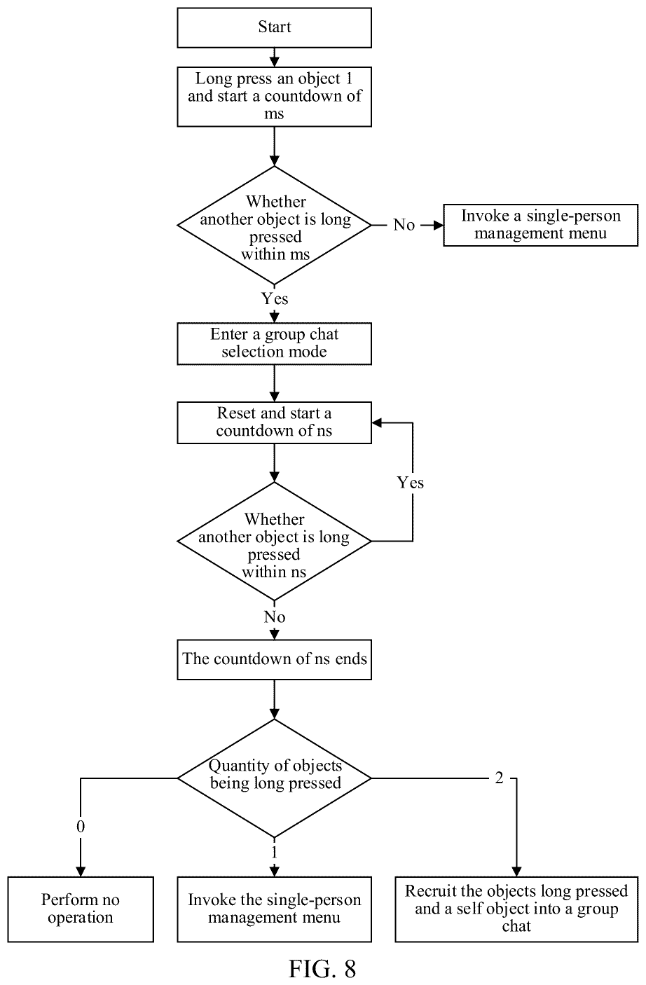

FIG. 8 is an operation flowchart according to an embodiment of this disclosure. As shown in FIG. 8, each operation of the flowchart is described as follows.

S1: A user long presses one object for ms, where m is duration that is set by a system and that is for responding to a single-object long pressing menu, and m is usually set to 2 s. Within the ms of the long pressing, if no other operation is performed, in other words, no other object is long pressed to trigger a group establishment operation, it is considered that, in this case, the user is to invoke an object management menu. After the ms, the object management menu is displayed.

S2: Within the foregoing ms in which one object is long pressed, if the user simultaneously long presses another user, it is considered that the user is to start establishing a group chat and a group-chat people-selection mode is entered. In this case, a countdown is refreshed and reset to ns. m and n may be set to different values based on a situation and experience.

S3: When the group-chat people-selection mode is entered, within the ns, each time an object that is not long pressed currently (the object may be an object that is long pressed before but is then released) is long pressed, the countdown is reset to ns. A function of resetting is to increase selection duration for the user and reduce selection anxiety.

S4: After the ns countdown ends, it is considered that the user ends people selection, and a quantity of long pressed objects is determined.

If the quantity is 0, in other words, the user releases and does not press any object, no operation is performed.

If the quantity is 1, in other words, only one user is long pressed, a management function is invoked and a management menu of the single object is displayed.

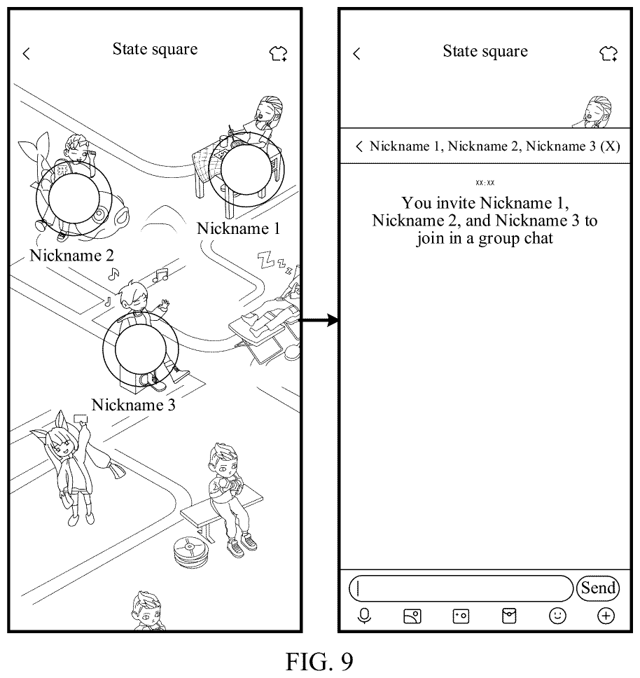

If the quantity is two or more, users corresponding to the objects and the user are recruited into the group chat and a group chat messaging page is opened. A diagram of an operation interface may be as shown in FIG. 9.

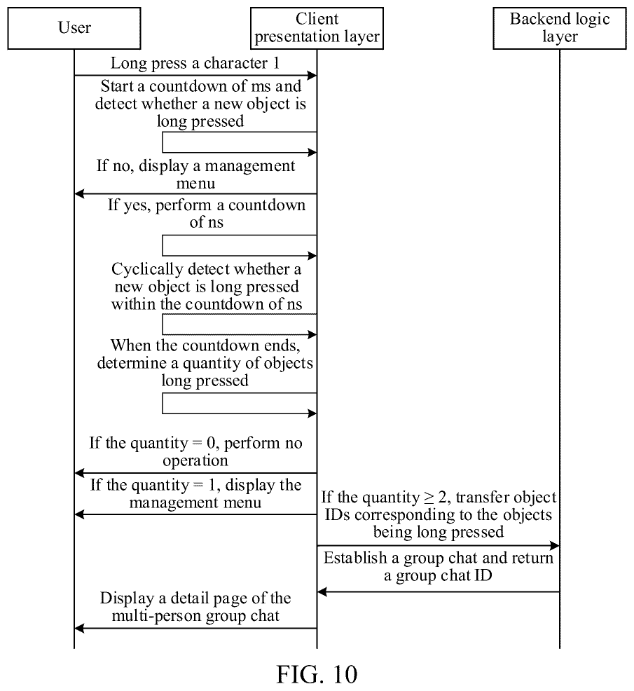

FIG. 10 is a diagram of a time sequence according to an embodiment of this disclosure. As shown in FIG. 10, in a possible solution of this disclosure, a specific diagram of a time sequence among a user, a client presentation layer, and a backend logic layer may be presented as follows.

(1) When the user long presses the 1^{st} object, a client starts a countdown of single-person long pressing. Before the countdown ends, if no other object is long pressed, a single-person management menu is displayed and the countdown ends.

(2) When the user long presses the 2^{nd} object within the countdown of the single-person long pressing, the client starts timing cyclically. Each time an object that is not long pressed is long pressed, the countdown is reset.

(3) Until the countdown ends, the client determines a quantity of objects being long pressed. When the quantity of the objects is two or more, the client transfers corresponding object identities (IDs) and a group establishment command to a backend interface.

(4) A backend corresponds the object IDs to account IDs, and transfers the account IDs and a group chat ID to a front end after a temporary group chat session is established. The front end completes pulling and presentation of a group page.

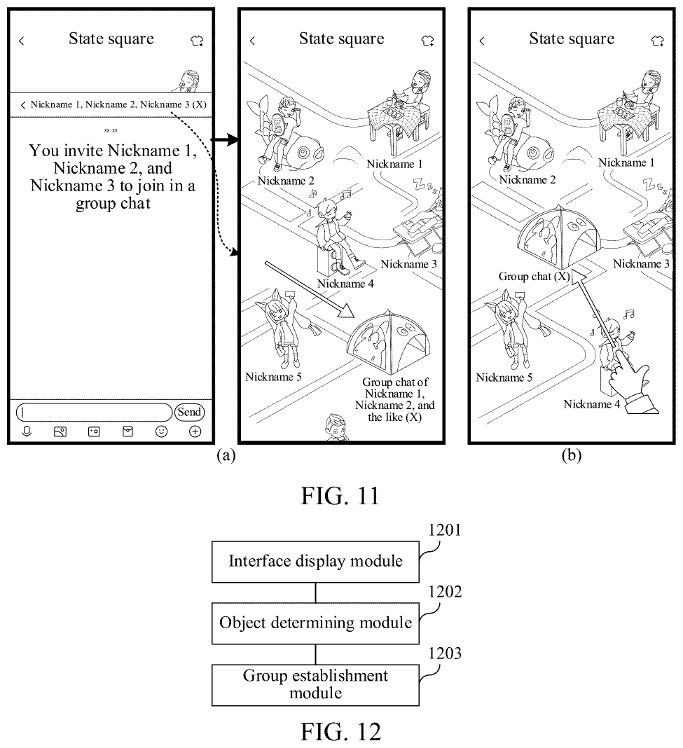

4. When the user returns to a scene from the group chat, a group chat entrance is added to the scene. The group chat entrance is tapped to open the group chat, so that it is convenient for the user to enter the group chat again and add a new object to the group chat. A diagram of an operation interface may be as shown in a part (a) in FIG. 11. In addition, as shown in a part (b) in FIG. 11, it may be convenient for the user to add a new object to the group chat.

This solution is an innovative manner for establishing a multi-person session in virtual social intercourse. A user usually puts friend objects that the user often communicates with together, or the user may zoom in or out a square screen to display objects that the user wants to chat with in a group within a range of one screen. In this case, it is convenient and fast to use the group establishment manner provided in this disclosure. The user completes, through long pressing, a plurality of operations from selecting a plurality of friends to performing group chatting. Based on an attribute of an object in an instant messaging application, group chatting is more active than point-to-point chatting. Therefore, this function is beneficial for promoting group chatting.

In some embodiments, in another possible implementation, a computer device may further set a group image, such as a tent, in a virtual scene. A user may drag an object in the virtual scene into the tent to perform a process of adding the object to a newly established group (corresponding to the solution shown in the foregoing operation 406).

In some embodiments, in another possible implementation, a computer device may further detect an operation of connecting a plurality of objects sequentially by a user to perform a process of adding the plurality of objects to a newly established group (corresponding to the solution shown in the foregoing operation 405).

FIG. 12 is a block diagram of a group establishment apparatus for a virtual scene according to an embodiment of this disclosure. The group establishment apparatus for a virtual scene may be configured to perform all or a part of the operations in the method shown in FIG. 3 or FIG. 4. As shown in FIG. 12, the group establishment apparatus for the virtual scene includes:
an interface display module 1201, configured to perform operation 310 in the embodiment of FIG. 3;
an object determining module 1202, configured to perform operation 320 in the embodiment of FIG. 3; and
a group establishment module 1203, configured to perform operation 330 in the embodiment of FIG. 3.

In a possible implementation, a touch operation includes at least two long-press operations performed successively, and the long-press operation is an operation of long pressing a position of a second virtual object.

The object determining module 1202 is configured to perform operations 402 to 404 in the embodiment of FIG. 4.

In a possible implementation, the apparatus further includes a first menu display module, configured to perform operation 404 in the embodiment of FIG. 4.

The object determining module 1202 is configured to perform operation 406 in the embodiment of FIG. 4.

In a possible implementation, the apparatus further includes a second menu display module, configured to perform operation 405 in the embodiment of FIG. 4.

In a possible implementation, the apparatus further includes: a first generation module, configured to generate a specified virtual item corresponding to a group in the virtual scene after the group is established; and a first virtual item display module, configured to display the specified virtual item in a scene interface.

An adding module is configured to add a third virtual object to the group in response to an operation of dragging the third virtual object to the specified virtual item.

The third virtual object is any second virtual object other than n group establishment virtual objects.

In a possible implementation, the apparatus further includes a messaging interface display module, configured to display an instant messaging interface corresponding to the group before displaying the specified virtual item, where the instant messaging interface includes a return control.

The first virtual item display module is configured to display the specified virtual item in response to receiving a trigger operation on the return control.

In a possible implementation, the apparatus further includes a movement module, configured to move a position of the specified virtual item in the virtual scene in response to a drag operation on the specified virtual item.

In a possible implementation, the object determining module 1202 is configured to perform operation 406 in the embodiment of FIG. 4.

In a possible implementation, the apparatus further includes: a second generation module, configured to: before determining, in response to receiving the touch operation on all or a part of at least two second virtual objects, the n group establishment virtual objects from the at least two second virtual objects based on the touch operation; and generate the specified virtual item in the virtual scene in response to receiving long-press operations simultaneously performed on two or more second virtual objects in the at least two second virtual objects; and a second virtual item display module, configured to display the specified virtual item.

In a possible implementation, the drag operation is an operation of dragging starting from a long-press operation.

In conclusion, in the solution shown in this embodiment of this disclosure, the n group establishment virtual objects selected by the user are determined directly by the received touch operation on all or the part of the at least two second virtual objects. Then the group of the n group establishment virtual objects and the first virtual object corresponding to the user is established. With help of an interaction manner in the virtual scene, an operation of group establishment is greatly simplified, thereby improving efficiency of human-computer interaction when the user establishes the group.

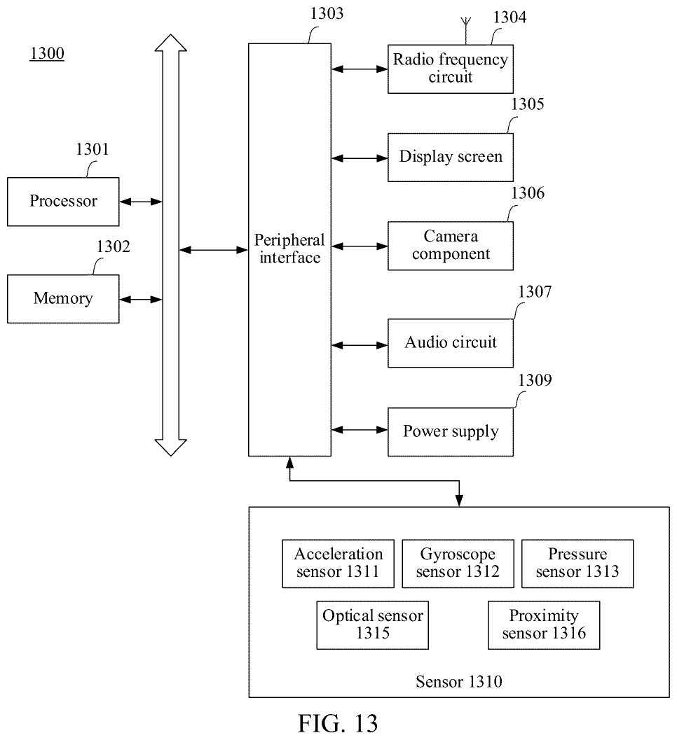

FIG. 13 is a block diagram of a structure of a computer device 1300 according to an embodiment of this disclosure. The computer device 1300 may be a portable mobile terminal, such as a smartphone, a tablet computer, a Moving Picture Experts Group Audio Layer III (MP3) player, a Moving Picture Experts Group Audio Layer IV (MP4) player, a notebook computer, or a desktop computer. The computer device 1300 may also be referred to as another name such as user equipment, a portable terminal, a laptop terminal, or a desktop terminal.

The computer device 1300 usually includes a processor 1301 (e.g., processing circuitry) and a memory 1302 (e.g., a non-transitory computer-readable storage medium).

The processor 1301 may include one or more processing cores, for example, a 4-core processor or an 8-core processor. The processor 1301 may be implemented by using at least one hardware form of a digital signal processor (DSP), a field-programmable gate array (FPGA), and a programmable logic array (PLA). The processor 1301 may alternatively include a main processor and a coprocessor.

The memory 1302 may include one or more computer-readable storage media. The computer-readable storage media may be non-transitory. The memory 1302 may further include a high-speed random access memory (RAM), and a non-volatile memory, for example, one or more disk storage devices and flash storage devices. In some embodiments, the non-transitory computer-readable storage medium in the memory 1302 is configured to store at least one computer instruction, and the at least one computer instruction is configured to be executed by the processor 1301 to implement the method provided in embodiments of this disclosure.

In some embodiments, the computer device 1300 further includes a peripheral interface 1303 and at least one peripheral. The processor 1301, the memory 1302, and the peripheral interface 1303 may be connected through a bus or a signal cable. Each peripheral may be connected to the peripheral interface 1303 through a bus, a signal cable, or a circuit board. Specifically, the peripheral includes: at least one of a radio frequency (RF) circuit 1304, a display screen 1305, a camera component 1306, an audio circuit 1307, and a power supply 1309.

In some embodiments, the computer device 1300 further includes one or more sensors 1310. The one or more sensors 1310 include, but are not limited to: an acceleration sensor 1311, a gyroscope sensor 1312, a pressure sensor 1313, an optical sensor 1315, and a proximity sensor 1316.

A person skilled in the art may understand that the structure shown in FIG. 13 does not constitute any limitation on the computer device 1300, and the computer device may include more components or fewer components than those shown in the figure, or some components may be combined, or a different component deployment may be used.

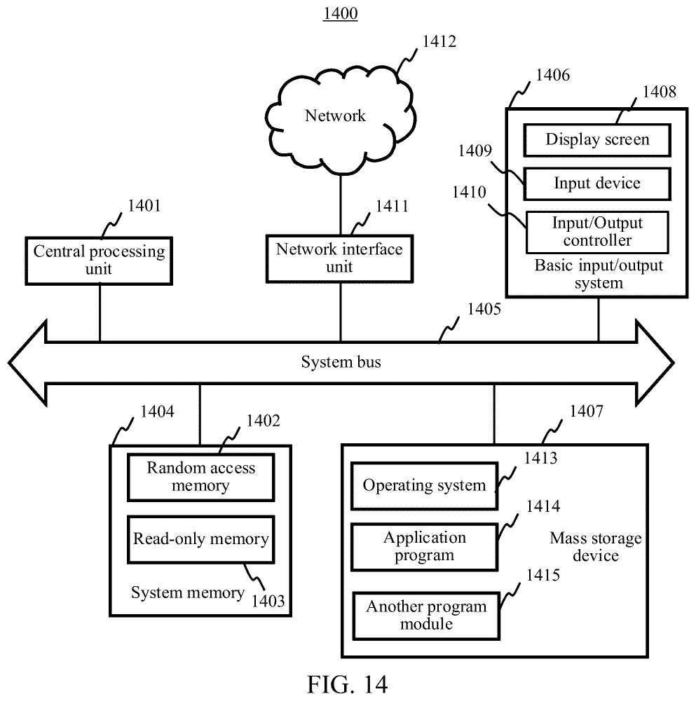

FIG. 14 is a block diagram of a structure of a computer device 1400 according to an embodiment of this disclosure. The computer device may be implemented as a group establishment apparatus for a virtual scene in the foregoing solutions in this disclosure. The computer device 1400 includes a central processing unit (CPU) 1401, a system memory 1404 including a random access memory (RAM) 1402 and a read-only memory (ROM) 1403, and a system bus 1405 connecting the system memory 1404 and the central processing unit 1401. The computer device 1400 further includes a basic input/output system (I/O) 1406 configured to transmit information between components in the computer, and a mass storage device 1407 configured to store an operating system 1413, an application program 1414, and other program module 1415.

The basic input/output system 1406 includes a display screen 1408 for displaying information and an input device 1409 such as a mouse, keyboard, or the like for a user to input information. The display screen 1408 and the input device 1409 are both connected to the central processing unit 1401 through an input-output controller 1410 connected to the system bus 1405. The basic input/output system 1406 may further include the input-output controller 1410 for receiving and processing input from a plurality of other devices such as a keyboard, a mouse, an electronic stylus. Similarly, the input-output controller 1410 also provides output to a display printer or other type of output device.

The mass storage device 1407 is connected to the CPU 1401 by using a mass storage controller (not shown) connected to the system bus 1405. The mass storage device 1407 and an associated computer-readable medium provide non-volatile storage for the computer device 1400. That is, the mass storage device 1407 may include a computer-readable medium (not shown) such as a hard disk or a compact disc ROM (CD-ROM) drive.

Without loss of generality, the computer-readable medium may include a computer storage medium and a communication medium. The computer storage medium includes volatile and non-volatile media, and removable and non-removable media implemented by using any method or technology and configured to store information such as a computer-readable instruction, a data structure, a program module, or other data. The computer storage medium includes a RAM, a ROM, an erasable programmable ROM (EPROM), an electrically erasable programmable ROM (EEPROM), a flash memory or another solid-state memory technology, CD-ROM, a digital versatile disc (DVD) or another optical memory, a tape cartridge, a magnetic cassette, a magnetic disk memory, or another magnetic storage device. Certainly, those skilled in the art may learn that the computer storage medium is not limited to the above. The foregoing system memory 1404 and mass storage device 1407 may be collectively referred to as a memory.

According to the embodiments of this disclosure, the computer device 1400 may further be connected, through a network such as the Internet, to a remote computer on the network. In other words, the computer device 1400 may be connected to a network 1412 through a network interface unit 1411 connected to the system bus 1405, or may be connected to another type of network or remote computer system (not shown) by using the network interface unit 1411.

The memory further includes at least one computer instruction, where the at least one computer instruction is stored in the memory, and through performing the at least one instruction, the central processing unit 1401 implements all or a part of the operations of the method in the foregoing embodiments.

In an embodiment, a non-temporary computer-readable storage medium, such as a non-transitory computer-readable storage medium including an instruction is further provided. For example, a memory including at least one computer instruction. The foregoing at least one computer instruction may be executed by a processor to implement all or a part of the operations in the method shown in any one of the embodiments of FIG. 3 or FIG. 4. For example, the non-transitory computer-readable storage medium may be a ROM, a RAM, a CD-ROM, a magnetic tape, a floppy disk, and an optical data storage device.

In an embodiment, a computer program product or a computer program is further provided. The computer program product or the computer program includes computer instructions, and the computer instructions are stored in a computer-readable storage medium. A processor of a computer device reads the computer instructions from the computer storage medium and executes the computer instructions, to cause the computer device to perform all or a part of the operations of the method shown in any one of the embodiments of FIG. 3 or FIG. 4.

What is claimed is:

1. A method for creating a group in a virtual environment, the method comprising:
displaying a first virtual object and a plurality of second virtual objects in the virtual environment;
receiving a touch input on at least one of the plurality of second virtual objects;
based on the at least one of the plurality of second virtual objects including at least two second virtual objects of the plurality of second virtual objects, selecting the at least two second virtual objects from the plurality of second virtual objects as group creation virtual objects; and
creating the group that includes the first virtual object and the group creation virtual objects.

2. The method according to claim 1, wherein, when the at least one of the plurality of second virtual objects includes the at least two second virtual objects of the second virtual objects, the receiving the touch input comprises:
receiving a plurality of long-press operations respectively corresponding to the at least two second virtual objects;
initiating a countdown timer when receiving a first long-press operation on one of the at least two second virtual objects;
resetting the countdown timer in response to receiving each subsequent long-press operation of the plurality of long-press operations before the countdown timer reaches zero; and
when the countdown timer reaches zero and at least two long-press operations are received, the selecting includes selecting the at least two second virtual objects corresponding to the received long-press operations as the group creation virtual objects.

3. The method according to claim 2, further comprising:
displaying a management interface for a single selected second virtual object when the countdown timer reaches zero and only one long-press operation is received, the only one long-press operation indicating that the at least one of the plurality of second virtual objects is one second virtual object.

4. The method according to claim 2, wherein
a duration of the initiated countdown timer and durations of the reset countdown timer are the same; or
the duration of the initiated countdown timer and the durations of the reset countdown timer are different.

5. The method according to claim 1, wherein
when the at least one of the plurality of second virtual objects includes the at least two second virtual objects, the receiving the touch input includes receiving a slide operation with a plurality of pause positions, each pause position indicating a location where the slide operation pauses for at least a predefined duration; and
when the slide operation is completed and at least two pause positions are detected, the selecting includes selecting the at least two second virtual objects corresponding to the detected pause positions as the group creation virtual objects.

6. The method according to claim 5, further comprising:
displaying a management interface for a single second virtual object when the slide operation is completed and only one pause position is detected, the only one pause position is detected indicating that the at least one of the plurality of second virtual objects is one second virtual object.

7. The method according to claim 1, further comprising:
generating and displaying a group identifier in the virtual environment after the group is created; and
adding a third virtual object to the group in response to a drag operation to move the third virtual object to a location of the group identifier, wherein the third virtual object is one of the plurality of second virtual objects not previously included in the group.

8. The method according to claim 7, further comprising:
displaying a group chat interface corresponding to the group, the group chat interface including a return control element; and
displaying the group identifier in response to activation of the return control element.

9. The method according to claim 8, further comprising:
moving the group identifier within the virtual environment in response to a drag operation on the group identifier.

10. The method according to claim 1, wherein
the receiving the touch input includes receiving a plurality of drag operations performed on the plurality of second virtual objects; and
when the plurality of drag operations are completed at a target location of a group identifier, the selecting includes selecting the plurality of second virtual objects corresponding to the received drag operations as the group creation virtual objects.

11. The method according to claim 10, further comprising:
generating the group identifier in the virtual environment in response to simultaneous long-press operations performed on the at least two second virtual objects; and
displaying the generated group identifier.

12. The method according to claim 11, wherein the drag operation starts from the long-press operation.

13. An apparatus, comprising:
processing circuitry configured to:
display a first virtual object and a plurality of second virtual objects in a virtual environment;
receive a touch input on at least one of the plurality of second virtual objects;
based on the at least one of the plurality of second virtual objects including at least two second virtual objects of the plurality of second virtual objects, select the at least two second virtual objects from the plurality of second virtual objects as group creation virtual objects; and
create a group that includes the first virtual object and the group creation virtual objects.

14. The apparatus according to claim 13, wherein, when the at least one of the plurality of second virtual objects includes the at least two second virtual objects, the processing circuitry is configured to:
receive a plurality of long-press operations respectively corresponding to the at least two second virtual objects;
initiate a countdown timer when a first long-press operation on one of the at least two second virtual objects is received;
reset the countdown timer in response to receiving each subsequent long-press operation of the plurality of long-press operations before the countdown timer reaches zero; and
when the countdown timer reaches zero and at least two long-press operations are received, the processing circuitry is configured to:
select the at least two second virtual objects corresponding to the received long-press operations as the group creation virtual objects.

15. The apparatus according to claim 14, wherein the processing circuitry is configured to:
display a management interface for a single selected second virtual object when the countdown timer reaches zero and only one long-press operation is received, the only one long-press operation indicating that the at least one of the plurality of second virtual objects is one second virtual object.

16. The apparatus according to claim 14, wherein
a duration of the initiated countdown timer and durations of the reset countdown timer are the same; or
the duration of the initiated countdown timer and the durations of the reset countdown timer are different.

17. The apparatus according to claim 13, wherein
when the at least one of the plurality of second virtual objects includes the at least two second virtual objects, the processing circuitry is configured to:
receive a slide operation with a plurality of pause positions, each pause position indicating a location where the slide operation pauses for at least a predefined duration; and
when the slide operation is completed and at least two pause positions are detected, the processing circuitry is configured to:
select the at least two second virtual objects corresponding to the detected pause positions as the group creation virtual objects.

18. The apparatus according to claim 17, wherein the processing circuitry is configured to:
display a management interface for a single second virtual object when the slide operation is completed and only one pause position is detected, the only one pause position being detected indicating that the at least one of the plurality of second virtual objects is one second virtual object.

19. The apparatus according to claim 13, wherein the processing circuitry is configured to:
generate and display a group identifier in the virtual environment after the group is created; and
add a third virtual object to the group in response to a drag operation to move the third virtual object to a location of the group identifier, wherein the third virtual object is one of the plurality of second virtual objects not previously included in the group.

20. A non-transitory computer-readable storage medium, storing instructions which when executed by a processor cause the processor to perform:
displaying a first virtual object and a plurality of second virtual objects in a virtual environment;
receiving a touch input on at least one of the plurality of second virtual objects;
based on the at least one of the plurality of second virtual objects including at least two second virtual objects of the plurality of second virtual objects, selecting the at least two second virtual objects from the plurality of second virtual objects as group creation virtual objects; and
creating a group that includes the first virtual object and the group creation virtual objects.
